(19) United States
(12) Patent Application Publication
(10) Pub. No.: US 2003/0095650 A1
(43) Pub. Date: May 22, 2003

(54) Caller data projector

(76) Inventor: Gary W. Mize, Leesville, LA (US)

Correspondence Address: Michael S. Neustel, Suite No.4, 2534 South University Drive, Fargo, ND, 58103, US

(21) Appl. No.: 09/990,154

(22) Filed: Nov. 21, 2001

(51) Int. Cl. H04M 1/64; H04M 11/00

(52) U.S. Cl. 379/142.17; 379/88.19; 379/93.23

(57) ABSTRACT

A method to receive calling party identification data and accept subscriber attached data for memory storage with projection as a focused lighted image on a flat surface is provided. The calling party identification data is received as Caller ID provided by the telephone service provider during the ring cycle of an incoming call and the subscriber attached data is additional information input by the called party for correlation and attachment to specific received calling party identification data. The lighted image is projected to provide a visual review of the calling party data in the form of grayscale or multicolor combination of text, characters or pictures from a viewing distance of two to forty feet in any ambient light.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to data projection. More specifically, the present invention provides a method and apparatus to determine, match and project telephone calling party identification and other related data for review by the called party.

2. Description of the Prior Art

Telephone companies began offering a new telephone service intended for residential and small business termed Calling Number Delivery (CND), better known as Caller ID, in the early 1990's. It allowed the called Customer Premises Equipment (CPE) to receive a calling party's directory number and the date and time of the call during the ring cycle of the incoming call. This new service provides the called party with the great advantage to screen incoming calls before accepting the call. To enjoy this service, the interested customer must request the additional service through the participating telephone company (agrees to pay a monthly fee or through another incentive program) and obtain and attach a commercially available Caller Id box to the phone line. In operation, limited caller identification is displayed on a small Liquid Crystal Display (LCD) after the first ring of an incoming call. The subscriber must find and read the small display to use the service.

FIG. 1 100 represents a functional block diagram of the prior art. The Caller ID 101 is commonly available as a small battery powered box, 3″×3″×2″ that attaches to the two-line simplex Tip and Ring telephone line 102 in the manner of a telephone extension or between the telephone service and telephone set. They include a caller identification module to decode the caller identification information 103, a few pushbuttons 106 to initiate a review and deletion of the information, a small liquid crystal display 105 to present the basic information of name, date, time and a basic microprocessor 106 with limited memory to store data entries and manage the box. These Caller ID boxes are available from many sources including Radio Shack, Southern Bell or General Electric with upscale versions integrated into other well known devices rather than the simple add on box described above. The patent entitled Universal Calling/Originating Number Identification issued Sep. 20, 1994 to Satyan G. Pitroda et al. is an example of the caller identification extended in decoded form to an associated computer, computer network and/or television screen for audio announcements, data manipulation and visual presentation options.

Most cellular telephone service networks offer a Caller ID service feature, presented on the small LCD screen with each incoming call, where the service feature is often “free” with a packaged service plan.

The American National Standards Institute (ANSI) (www.ansi.org/) has standardized two methods for Caller ID used in telephone Advanced Intelligent Networks. The first utilizes an optional information element in a signaling system 7 (SS7) ISUP initial address message (IAM) and the second method uses a SS7 TCAP message to query a Service Control Point.

FIG. 5 is a timing diagram 500 of the Caller Identification information added to the telephone signaling protocol provided to the subscriber CPE. The information 501 is presented on the subscriber telephone line as a 1200 baud, analog phase-coherent Frequency Shift Key (FSK) data stream across the two-wire simplex type (typical telephone lines) usually transmitted during the first 4 second silent interval between the first 502 and second call rings 503 of the ringing cycle. The Central Office is signaled the “off hook” position when the called party has “picked up” by answering machine or other means 504 which electrically loads and drives the signaling telephone line voltage from 48 volts to about 6 volts DC for the Central Office to recognize and suspend the ring cycle and connect the caller 505 conversation or digital (FAX/Modem) data. Picking up the receiver before the data stream is finished, before the second ring, will stop/corrupt the transmission.

For more information on Calling Number Delivery protocol specifications, refer to Bellcore publications TR-TSY-000030 and TR-TSY-000031 through Bellcore Customer Service in Piscataway, N.J. Bellcore, or Bell communications Research Inc., was established after the breakup of AT&T in 1984 to provide engineering, administrative and other services to the newly created seven regional holding companies: Ameritech, Bell Atlantic, Bell South, NYNEX, Pacific Telesis, SBC Communications and US West and pioneered many of the telecommunications services that are commonplace today including Caller ID, Call Waiting and toll-free service.

Currently, there are two types of Caller ID. The first type, or “basic service”, contains the date and time of the call and the calling number or an error message. The second type includes the basic information of the first with a name and possibly the address (directory information) of the calling telephone. Today, Caller ID boxes generally present the information in the following format:

Thomsen, Wil

703-456-3255

#09 8/07 7:14 PM

In the above example, “Wil” is a truncated “William” due to limited display space on the first line of three and the “#09” is added by the Caller ID box to indicate the ninth chronologically stored entry for easy reference during review.

For privacy purposes, many telephone companies that provide Caller ID are also required to provide the ability for a calling party to suppress the Caller ID signal. Consequently, the Caller ID box may display “Blocked” or “Private” as well as error messages that include “Out of Area”, “Buffer Full” (limited number of stored call data), “Data Error” or “No Data Sent”. To counter this calling party privacy control in view of the called party, some telephone service companies return a message to the calling party to select to complete the call by allowing the calling party identification to be transferred for only the current call or select to terminate the call. This new approach to calling party identification insures the identity of a reputable caller is received; obnoxious calls are dropped.

It is the object of the present invention to provide Caller ID service along with subscriber attached data where the complete calling party data is projected to a flat surfaced wall, ceiling or other similar surface. The projected data is convenient to find and review with all the necessary information presented for the called party to determine whether to answer an incoming call or with review of logged data, return the call at a later time.

### SUMMARY OF THE INVENTION

Caller data with projected display is an enhanced method for the called party to conveniently screen incoming calls before selectively answering the call. For example, the subscriber need only to glance up from a desk, bed or couch to the nearby wall or ceiling to identify the source of the call and determine whether to “pick up” and accept the call. The essential information to determine call acceptance is provided in large characters so as to be easily understood from across the room. The image would appear for a period of time pre-selected by the user with automatic or manual means to adjust the image intensity so as to be clearly discernable in the ambient light, day or night.

The Caller Data Projector is an excellent alternative to an answering or recording machine in that the key data is reliably captured and visually presented for easy review from any ongoing room activity for every call. The inventive system does not require nor is it dependent on the calling party to leave a message, the message necessary for calling party identity. For call screening purposes, the called party is relieved of waiting through a number of rings for an answering machine to pick up, listening to his own out going message and sorting through the message, if any, input by the calling party. With visual data presentation of the essential data, the inventive solution does not annoy others with the live or loud audio playback message, a message that is often lengthy and largely unnecessary.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a prior art block diagram of a typical Calling Number Delivery apparatus.

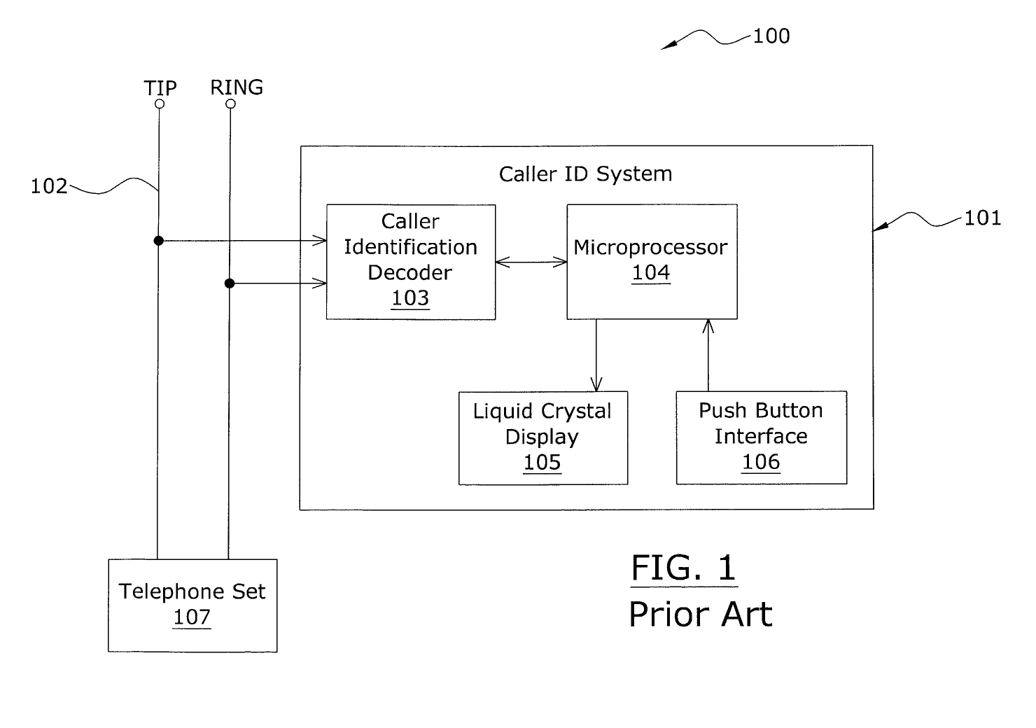

FIG. 2 shows a block diagram of a preferred embodiment of the invention combining caller identification and called party attached data with a data projector.

FIG. 3 shows a block diagram of the preferred embodiment of the data projector utilizing Digital Light Processing circuits with lamp and lens projection apparatus.

FIG. 4 shows an enlarged view of the architecture of two micromirrors on the Digital Micromirror Device.

FIG. 5 is a timing diagram of the caller identification information added to the telephone service signaling protocol.

FIG. 6 shows the steps to set-up the preferred embodiment of the invention.

### DESCRIPTION OF THE PREFERRED EMBODIMENT

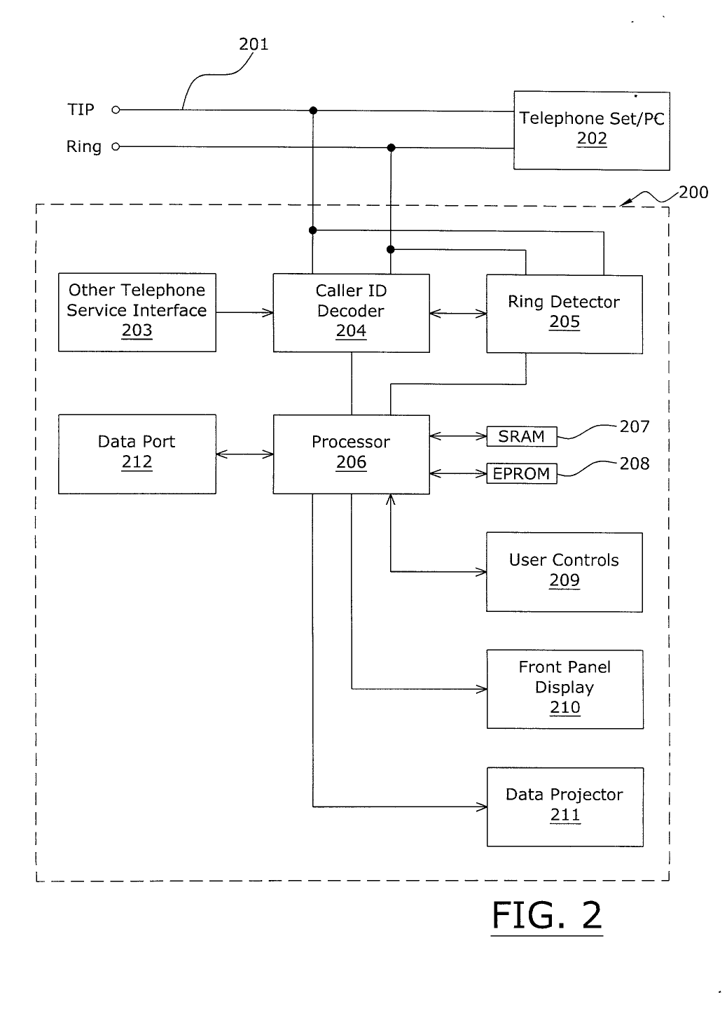

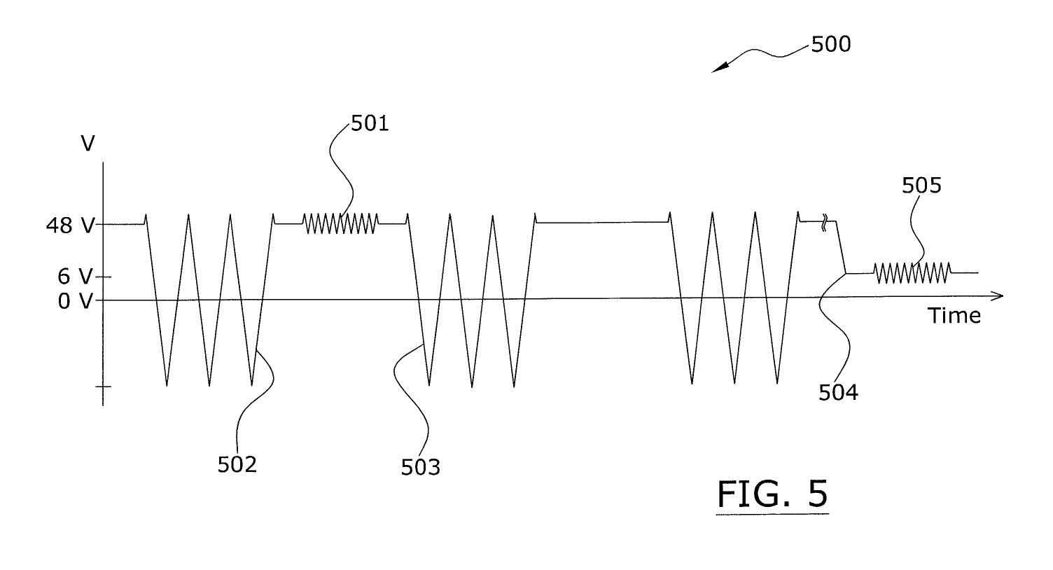

FIG. 2 shows a block diagram of a preferred embodiment of the invention. The inventive Caller Data Projector (CDP) 200 is connected between the Tip and Ring 201 telephone line pair and local telephone set or PC 202. The CDP connection is designed to monitor the telephone line signal levels or data/ conversation information such that normal telephone service and digital data services are not impaired. The Caller ID decoder 204 receives, decodes and provides a serial stream of the caller identification to the processor 206 for subsequent data handling. The decoder is a Frequency Shift Key (FSK) receiver that expects an analog phase-coherent FSK transmission rate of 1200 bps at a compatible transmission level from the telephone service. This Caller ID decoder may be a Motorola MC145447 HCMOS integrated circuit or a Data Access Arrangement (DAA) modem modified to prevent the DAA to go off hook in the conventional sense. Both approaches best utilize a ring detector 205 to signal the decoder to “wake up” and monitor the period of time between the first and second rings. As previously discussed for FIG. 5, the universally accepted Caller ID protocol in the United States is specified in Bellcore publication TR-TSY-000031. Detecting, processing and displaying the caller identification data is accomplished prior to the second ring.

In FIG. 2, the central processor 206 processes the serial data from the FSK decoder in a manner dictated by a software program stored on the erasable programmable read only memory (EPROM) 208. The EPROM provides an inexpensive means to store control directions as well as facilitate upgrades through chip replacement. The static random access memory (SRAM) integrated chip 207 provides storage for call data memory (approximately 100 entries), subscriber selected feature options and attachments and temporary data storage for the central processor data handling. The user controls 209 include input buttons, preferably an alphanumeric keypad, for basic user input in response to a software driven menu. A common USB or other commonly known serial port data protocol is utilized at data port 212 to input advanced called party data attachments such as calling party identity pictures or other pictorial images to be correlated with individual or all calling party identities. The user controls would also provide the basic default steps for menu access, data review, deletion and image intensity manual override. An optional front panel display 210 is supplied to perform the same function as the projected display, realized as an inexpensive liquid crystal or vacuum fluorescent display.

The Caller Data Projector works equally well with other methods to connect with a telephone service provider. Other telephone service interface 203 is shown in FIG. 2 to represent these methods that include an infrared port (IR) with an adjacent similarly equipped telephone set or a wireless method such as Bluetooth TM developed by Motorola, Ericsson, Nokia, Microsoft and other major telecommunication service providers. Bluetooth provides a convenient connection alternative for CDP where this product is a small add-on wireless link for wireless data transfer and product control between services and mobile computers, cellular telephones and other devices such as the CDP.

FIG. 2 also features a Data Projector 211 to provide the inventive projection of the caller identification and user attached data for the CDP. The projector projects selected data with sufficient resolving power and light intensity for the data to be viewed on a commonly sized residential room or business office for viewing typically from 2 to 40 feet. The CDP box includes a flush mounted projection lens utilizing thumb wheels and gear system to selectively direct and focus the image. The preferred data projecting method is the reflective type projector where light is bounced off an image forming element to create the image. These Digital Light Projecting (DLP) technologies include the Digital Micromirror Device (DMD), pioneered by Texas Instruments, the Grating Light Valve (GLV) developed at Stanford University and produced by Silicon Light Machines and Liquid Crystal on Silicon (LCOS).

The GLV chip consists of tiny reflective ribbons mounted over a silicon chip. The individual ribbons move toward the chip by a fraction of the wavelength of the illuminating light when a voltage is applied to the chip below a ribbon. The deformed ribbons form a diffraction grating and the various orders of light can be combined to form the pixel of an image. Light from a red, green and blue shines on the GLV and is rapidly scanned across the display screen at 60 times a second to form the image.

LCOS is a new LCD technology where, in contrast to nematic twisted LCDs in which the crystals and electrodes are sandwiched between polarized glass plates, LCOS devices have the crystals coated over the surface of a silicon chip. LCOS devices have been successfully used in projection TVs by Philips and can also be used for microdisplays used in wearable near-eye projections.

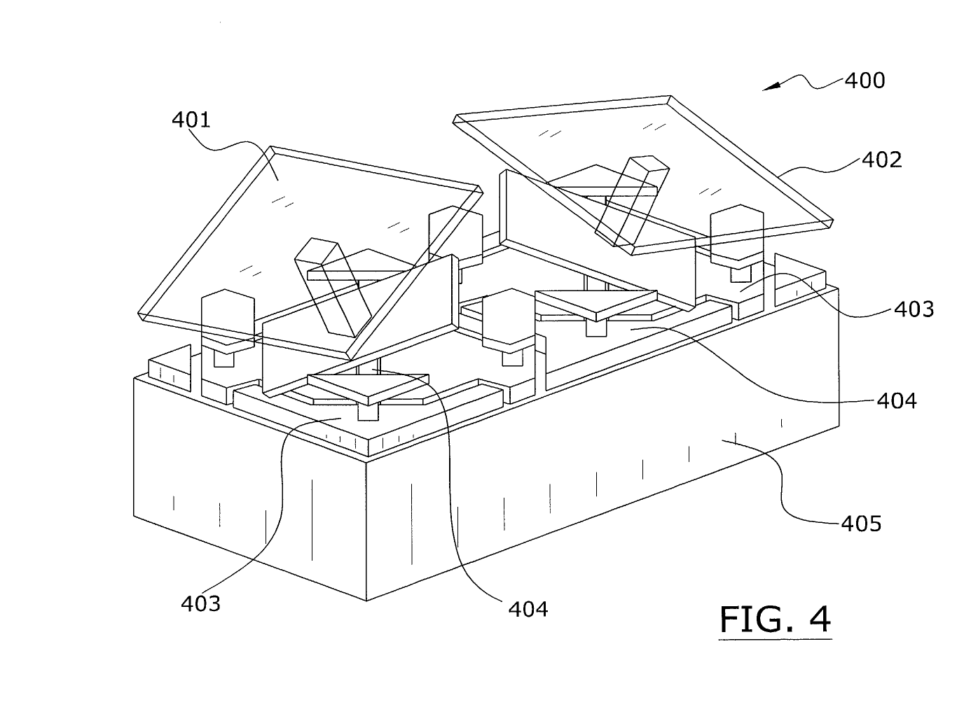

A Digital Micromirror Device is a chip with 800 to 1 million tiny mirrors depending on the selected size of the array or resolution. FIG. 4 shows a blow up of just two of the microscopic mirrors 401, 402 tilted up to opposite +10 and −10 degree directions as referenced to a imaginary perpendicular line with the chip base 405. The light hitting the left mirror would be reflected towards the projection apparatus or “on” where the right hand mirror 402 would reflect the light away from the projection apparatus or “off”. The electrodes 403 receives electrical current from the DLP driver circuits to force a yoke 404 to bend thereby driving the individual mirror to tilt to an “on” or “off” direction. A micromirror can switch on or off more than 50,000 times per second according to directions from the image code. A beam of light reflects this grayscale image off the DMD's surface. Current arrays are offered comparable to current popular display resolutions: SVGA-848×600, XGA-1024×768 and SXGA-1280×1024 where the array selection depends on the image quality and to some extent, the image brightness desired at the given view size. A DLP based projector brightness increases with greater resolution since the larger DMD array provides a larger reflection area to maximize the lamp brightness.

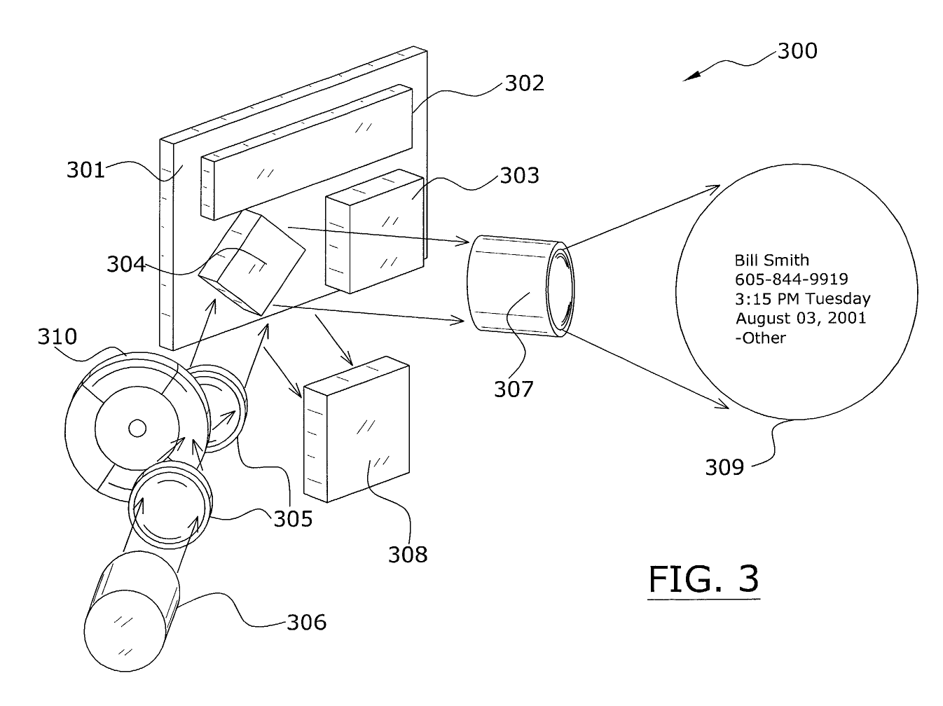

The inventive CDP preferably uses the data projector shown in FIG. 3. The system 300 is based on DMD chip 304 previous discussed on a DLP board 301. The DLP processor 302 with a SRAM chip 303 is a multi-source translator. It rapidly converts digital content supplied by the central processor 206 into a digital bit stream that can be read by the DMD. A lamp 306 provides light through a suitable convex type lens 305 to direct the light onto the DMD's reflective face at an appropriate angle such that the DMD can direct the light toward the projection lens 307 for the signal “on” state or toward the light absorber 308 to create the signal “off” state. A color wheel 310 under processor control is optionally added to provide a color image. The color wheel spins in sequence with the red, green and blue video signals being sent to the DMD. The mirrors are turned on, depending on where and how much of each color is needed for each television field to be visually integrated by the human eye for a full-color image. The projection lens receives the “on” information and with appropriate focal length and aperture to project the focused “on” image to the viewing surface 309. A simple focus thumb wheel to focus the projector lens would be provided on a convenient surface of the CDP. A brightness control circuit 310, circuits well known in the art, monitors ambient light to automatically select lamp brightness sufficient for the projected caller data to be read at various day and nighttime ambient light levels. The CDP front panel would also provide a button to manually override the automatic light intensity setting. During CDP installation, the software driven set-up menu would provide means to rotate the image through directions to the DMD chip.

In a second embodiment of the inventive Caller Data Projector, the data projector 211 alternatively utilizes projectors that shine light through the image forming element. These transmittive type projectors include the well known liquid crystal display panel or a vacuum fluorescent display with a projecting lens to collect, focus and project the image on a nearby surface.

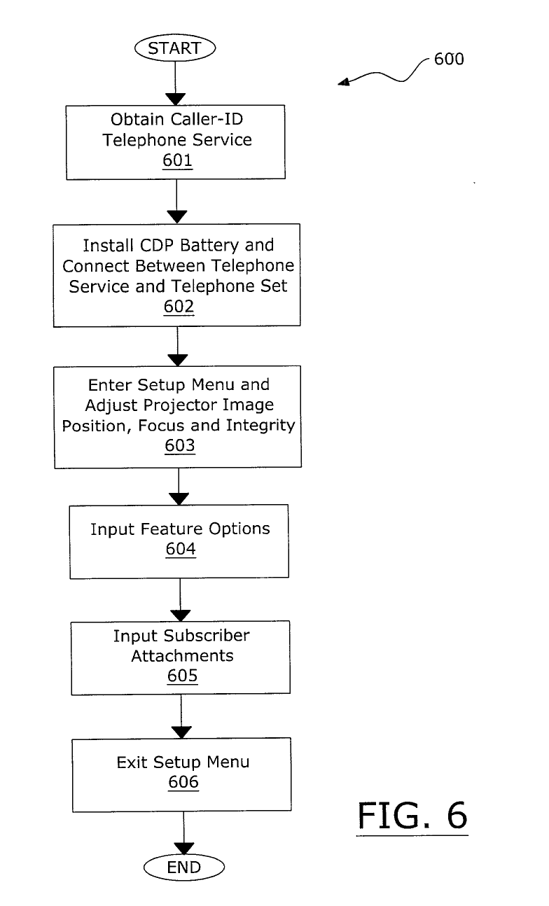

FIG. 6 shows the straightforward steps to set-up 600 the Caller Data Projector. With service activation 601, service connection and installation of a battery/wall plug

The inventive CDP preferably uses the data projector shown in FIG. 3. The system 300 is based on DMD chip 304 previous discussed on a DLP board 301. The DLP processor 302 with a SRAM chip 303 is a multi-source translator. It rapidly converts digital content supplied by the central processor 206 into a digital bit stream that can be read by the DMD. A lamp 306 provides light through a suitable convex type lens 305 to direct the light onto the DMD's reflective face at an appropriate angle such that the DMD can direct the light toward the projection lens 307 for the signal “on” state or toward the light absorber 308 to create the signal “off” state. A color wheel 310 under processor control is optionally added to provide a color image. The color wheel spins in sequence with the red, green and blue video signals being sent to the DMD. The mirrors are turned on, depending on where and how much of each color is needed for each television field to be visually integrated by the human eye for a full-color image. The projection lens receives the “on” information and with appropriate focal length and aperture to project the focused “on” image to the viewing surface 309. A simple focus thumb wheel to focus the projector lens would be provided on a convenient surface of the CDP. A brightness control circuit 310, circuits well known in the art, monitors ambient light to automatically select lamp brightness sufficient for the projected caller data to be read at various day and nighttime ambient light levels. The CDP front panel would also provide a button to manually override the automatic light intensity setting. During CDP installation, the software driven set-up menu would provide means to rotate the image through directions to the DMD chip.

In a second embodiment of the inventive Caller Data Projector, the data projector 211 alternatively utilizes projectors that shine light through the image forming element. These transmittive type projectors include the well known liquid crystal display panel or a vacuum fluorescent display with a projecting lens to collect, focus and project the image on a nearby surface.

FIG. 6 shows the straightforward steps to set-up 600 the Caller Data Projector. With service activation 601, service connection and installation of a battery/wall plug insertion 602, the CDP is ready for programming where the front panel buttons provide called party access to a set-up menu data presented by image. In the next step 603 the projected image brightness is adjusted followed by image positioning and focusing. The menu prompts feature option selection 604 and called party data attachments 605 correlated with the selected or all caller identity telephone numbers as appropriate and stored in memory. Pre-stored feature options include, but are not limited to, period of time to project the data image for each incoming call, manually/automatically select image brightness, audible alarm with specific calling numbers, continual display or flash display of pre-selected received calling parties, enable/disable the storage and display of the number of times a calling number is received in a specified time period and front panel indicator lights (LED's) programming. The indicators are selected to illuminate for an incoming call, buffer full or weak battery or other conveniences well known in the art. With exit of the set-up menu 606, the CDP is active to receive, process and project the calling party data with the front panel buttons enabled to trigger basic review and/or deletion of logged entries.

It will be appreciated that in general, the inventive product receives Caller ID, is combined with other subscriber selected data and projects the calling party data for convenient viewing from below or across the room during an ongoing activity.

While specific embodiments of the invention have been described and illustrated, such embodiments should be considered illustrative of the invention only and not as limiting the invention as construed in accordance with the accompanying claims.

I claim:

1. A method of projecting calling party data, comprising:
inputting called party data attachments and feature options to memory;
receiving calling party identification data from a telephone service provider;
logging called party data attachments correlated with received calling party identification; and
projecting called party data attachments with received calling party identification data as a lighted image to a flat surface for visual comprehension.

2. A method as claimed in claim 1 wherein said receiving calling party identification comprises a hardwired or wireless connection to the telephone service provider.

3. A method as claimed in claim 1 wherein said projecting comprises a light directed through an image forming element and focused projection lens.

4. A method as claimed in claim 3 where said image forming element comprises a liquid crystal display or vacuum fluorescent display.

5. A method as claimed in claim 1 wherein said projecting comprises a light reflected off the image forming element and directed through a focused projection lens.

6. A method as claimed in claim 5 where said image forming element comprises a digital micromirror device, grating light valve or liquid crystal on silicon.

7. A method as claimed in claim 6 wherein said lighted image comprises a grayscale image or multi-color image.

8. A method as claimed in claim 5 where said lighted image comprises a static image, dynamic image or a combination of dynamic and static images.

9. A method as claimed in claim 5 wherein said lighted image comprises text, characters or pictures.

10. A method as claimed in claim 1 where said lighted image further comprises means for manual or automatic light intensity adjustment of said lighted image.

11. A method as claimed in claim 1 where said projecting further comprises projection for a period of time specified by the called party with each received call or request by the called party after the call.
